(19) United States
(12) Patent Application Publication
(10) Pub. No.: US 2025/0242302 A1
(43) Pub. Date: Jul. 31, 2025

(54) CARBON DIOXIDE IMMOBILIZATION SYSTEM AND CARBON DIOXIDE IMMOBILIZATION METHOD

(71) Applicant: TOYOTA JIDOSHA KABUSHIKI KAISHA, Toyota-shi (JP)

(72) Inventors: Yoshiteru YAZAWA, Nagoya-shi (JP); Akira KATO, Toyota-shi (JP); Koseki SUGIYAMA, Sunto-gun (JP); Masahiko TAKEUCHI, Toyota-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 18/987,907

(22) Filed: Dec. 19, 2024

(30) Foreign Application Priority Data
Jan. 26, 2024 (JP) 2024-010535

(51) Int. Cl. B01D 53/62; B01D 53/34; B01D 53/75; B01D 53/81

(52) U.S. Cl. CPC B01D 53/62; B01D 53/346; B01D 53/75; B01D 53/81; B01D 2251/40; B01D 2257/504; B01D 2259/40009

(57) ABSTRACT

A carbon dioxide immobilization system includes: a carbon dioxide capture apparatus in which a solid adsorbent is caused to adsorb carbon dioxide in a first gas, then the solid adsorbent is heated and depressurized, and a second gas containing a higher concentration of carbon dioxide than the first gas does is extracted; a carbonate generation apparatus configured to cause carbon dioxide in the second gas extracted from the carbon dioxide capture apparatus to be reacted with an alkaline earth compound to generate carbonate; and a sensor configured to detect a concentration of carbon dioxide in the second gas is provided. A degree of depressurization in the carbon dioxide capture apparatus is controlled by feedback in such a way that the concentration of carbon dioxide detected by the sensor is maintained within a predetermined target concentration range.

### CROSS REFERENCE TO RELATED APPLICATIONS

This application is based upon and claims the benefit of priority from Japanese patent application No. 2024-010535, filed on Jan. 26, 2024, the disclosure of which is incorporated herein in its entirety by reference.

### BACKGROUND

The present disclosure relates to a carbon dioxide immobilization system and a carbon dioxide immobilization method.

As a technology for reducing carbon dioxide (hereinafter also referred to as CO₂), a Direct Air Capture (DAC) that directly captures CO₂ in the atmosphere is known. Patent Literature 1 discloses a DAC that uses a chemical absorption method for capturing CO₂ in the atmosphere by causing an absorption liquid to absorb CO₂.

The captured CO₂ is immobilized by, for example, reacting it with alkaline earth compounds to generate carbonate.
Patent Literature 1: Japanese Unexamined Patent Application Publication No. 2023-131882

### SUMMARY

It is known that, in the chemical absorption method disclosed in Patent Literature 1 and so on, a large amount of energy is required to extract CO₂ from an absorption liquid that has absorbed CO₂.

The inventors have examined a chemical adsorption method which has a higher energy efficiency than that of the chemical absorption method. In the chemical adsorption method, a solid adsorbent that has adsorbed CO₂ is heated and depressurized, thereby extracting CO₂.

However, if the concentration of CO₂ is too high when carbonate is generated and CO₂ is immobilized, this may result in there being an excessive amount of CO₂ that does not react with alkaline earth compounds and thus may be released into the atmosphere again. On the other hand, if the concentration of CO₂ is too low, it is possible that the reaction time may become longer.

The present disclosure has been made in view of the aforementioned circumstances, and provides a carbon dioxide immobilization system capable of preventing the causing of an excessive amount of carbon dioxide while reducing the reaction time.

A carbon dioxide immobilization system according to the present disclosure includes: a carbon dioxide capture apparatus in which a solid adsorbent is caused to adsorb carbon dioxide in a first gas, then the solid adsorbent is heated and depressurized, and a second gas containing a higher concentration of carbon dioxide than the first gas does is extracted; a carbonate generation apparatus configured to cause carbon dioxide in the second gas extracted from the carbon dioxide capture apparatus to be reacted with an alkaline earth compound to generate carbonate; and a sensor configured to detect a concentration of carbon dioxide in the second gas, in which a degree of depressurization in the carbon dioxide capture apparatus is controlled by feedback in such a way that the concentration of carbon dioxide detected by the sensor is maintained within a predetermined target concentration range.

A carbon dioxide immobilization method according to the present disclosure is a carbon dioxide immobilization method including: causing a solid adsorbent to adsorb carbon dioxide in a first gas; heating and depressurizing the solid adsorbent and extracting a second gas containing a higher concentration of carbon dioxide than the first gas does; and causing carbon dioxide in the extracted second gas to be reacted with an alkaline earth compound to generate carbonate, in which when the second gas is extracted, a concentration of carbon dioxide in the extracted second gas is detected, and a degree of depressurization when carbon dioxide is extracted from the solid adsorbent is controlled by feedback in such a way that the detected concentration of carbon dioxide is maintained within a predetermined target concentration range.

In one aspect according to the present disclosure, the degree of depressurization when carbon dioxide is extracted is controlled by feedback in such a way that the concentration of carbon dioxide in the second gas extracted from the solid adsorbent is maintained within a predetermined target concentration range. Therefore, when carbonate is generated and carbon dioxide is immobilized, the concentration of carbon dioxide in the second gas can be maintained within a predetermined target concentration range, and it is thus possible to prevent the causing of an excessive amount of carbon dioxide while reducing the reaction time.

When the concentration of carbon dioxide detected by the sensor is lower than the predetermined target concentration range, the degree of depressurization may be increased, and when the concentration of carbon dioxide detected by the sensor is higher than the predetermined target concentration range, the degree of depressurization may be decreased.

Further, the alkaline earth compound may be included in incinerated ash, slag, or seawater.

According to the present disclosure, it is possible to provide a carbon dioxide immobilization system capable of preventing the causing of an excessive amount of carbon dioxide while reducing the reaction time.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a carbon dioxide immobilization system according to a first embodiment;

FIG. 2 is a graph showing a relation between a pressure when CO₂ is extracted and a CO₂ concentration; and

FIG. 3 is a flowchart showing a carbon dioxide immobilization method according to the first embodiment.

### DESCRIPTION OF EMBODIMENTS

Hereinafter, with reference to the drawings, specific embodiments of the present disclosure will be described in detail. However, the present disclosure is not limited to the following embodiments. Further, for the sake of clarification of the description, the following descriptions and the drawings are simplified as appropriate.

### First Embodiment

### <Configuration of Carbon Dioxide Immobilization System>

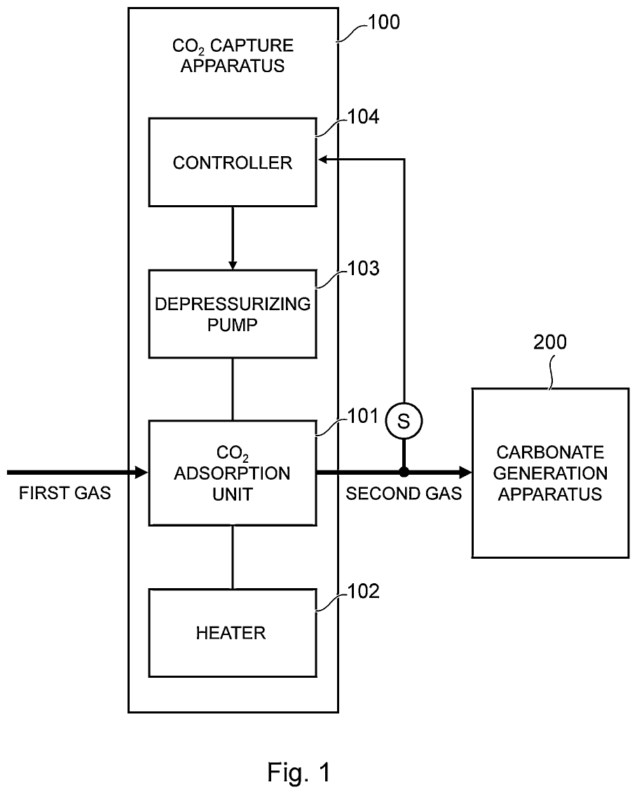

First, with reference to FIG. 1, a configuration of a carbon dioxide immobilization system according to a first embodiment will be described. FIG. 1 is a block diagram showing a configuration of the carbon dioxide immobilization system according to the first embodiment. In FIG. 1, thick arrows indicate a flow of gas.

As shown in FIG. 1, the carbon dioxide immobilization system according to this embodiment includes a CO₂ capture apparatus 100, a carbonate generation apparatus 200, and a sensor S. The CO₂ capture apparatus 100 includes a CO₂ adsorption unit 101, a heater 102, a depressurizing pump 103, and a controller 104.

The CO₂ capture apparatus 100 is, for example, a direct air capture apparatus that uses a chemical adsorption method by a solid adsorbent.

As shown in FIG. 1, in the CO₂ capture apparatus 100, CO₂ in a first gas is caused to be adsorbed in the solid adsorbent included in the CO₂ adsorption unit 101. The first gas here is not limited to the atmosphere and includes exhaust gas from factories, cars, etc. Gases other than CO₂ in the first gas pass through the CO₂ adsorption unit 101 and then simply discharged.

After that, in the CO₂ capture apparatus 100, the CO₂ adsorption unit 101 that has adsorbed CO₂ (i.e., the solid adsorbent) is heated by the heater 102 and is depressurized by the depressurizing pump 103. According to this configuration, a second gas containing a higher concentration of CO₂ than the first gas does is extracted from the CO₂ capture apparatus 100.

That is, in the CO₂ capture apparatus 100, a process of causing the first gas to pass through the CO₂ adsorption unit 101 to capture CO₂ at a normal temperature and a process of heating the CO₂ adsorption unit 101 to, for example, about 100° C. and depressurizing the CO₂ adsorption unit 101 to extract CO₂ are repeated.

In the CO₂ adsorption unit 101, for example, a first gas is caused to contact a porous carrier on which a solid adsorbent is supported, and CO₂ in the first gas is caused to be adsorbed by the carbon dioxide absorbent, thereby capturing CO₂. The porous carrier on which the solid adsorbent is supported is, for example, but not limited, coated on a base having a honeycomb structure.

The solid adsorbent is, for example, but not limited to, hydrophilic polymers, and more specifically, polyethyleneimine, or amine-based polymers such as a primary amine, a secondary amine, or a secondary alkanolamine.

The heater 102 is a heating apparatus for heating the CO₂ adsorption unit 101 when CO₂ is extracted from the solid adsorbent that has adsorbed CO₂. The heater 102 is controlled by, for example, a controller 104.

The depressurizing pump 103 is a depressurizing apparatus for depressurizing the CO₂ adsorption unit 101 when CO₂ is extracted from the solid adsorbent that has adsorbed CO₂. The depressurizing pump 103 is controlled by, for example, the controller 104.

Note that the depressurizing pump 103, which is one example of a depressurizing apparatus, includes a vacuum pump.

As shown in FIG. 1, the controller 104 performs feedback control on the depressurizing pump 103 based on the concentration of CO₂ in the second gas detected by the sensor S. More specifically, the controller 104 provides feedback control of the degree of depressurization in the CO₂ adsorption unit 101 by the depressurizing pump 103 in such a way that the concentration of CO₂ detected by the sensor S is maintained within a predetermined target concentration range.

More specifically, when the concentration of CO₂ detected by the sensor S is lower than the predetermined target concentration range, it is possible that the reaction time when carbonate is generated in the carbonate generation apparatus 200 may be long. In this case, the degree of depressurization by the depressurizing pump 103 is increased.

Meanwhile, when the concentration of CO₂ detected by the sensor S is higher than the predetermined target concentration range, it is possible that excessive CO₂ that does not react with alkaline earth compounds in the carbonate generation apparatus 200 may be released into the atmosphere again. In this case, the degree of depressurization by the depressurizing pump 103 is decreased.

When the rotation speed of the depressurizing pump 103 is increased, the degree of depressurization is increased, and when the rotation speed of the depressurizing pump 103 is decreased, the degree of depressurization is decreased.

Although not shown in FIG. 1, the controller 104 includes, for example, an arithmetic unit such as a Central Processing Unit (CPU), and a memory such as a Random Access Memory (RAM) or a Read Only Memory (ROM) that stores various programs, data, or the like. That is, the controller 104 includes a function as a computer, and performs various kinds of processing based on the various programs or the like described above.

The carbonate generation apparatus 200 into which the second gas extracted from the CO₂ capture apparatus 100 is introduced causes CO₂ in the second gas to be reacted with alkaline earth compounds to generate carbonate. The carbonate here is a carbonate of an alkaline earth metal and includes bicarbonate or a hydrate.

As the alkaline earth compound, an alkaline earth compound itself may be added. From the viewpoint of reducing environmental load, incinerated ash, slag, seawater or the like may be used. The incinerated ash or the like itself may be used, or incinerated ash or the like from which compounds that disturb CO₂ immobilization are removed in advance may be used. That is, incinerated ash or the like is not limited as long as CO₂ immobilization can be achieved, and may contain components other than the alkaline earth compounds.

The alkaline earth compound is a compound including an alkaline earth metal element, and is, for example, a hydrosoluble alkaline earth compound. Examples of the water-soluble alkaline earth compound may include alkaline earth metal oxides, alkaline earth metal nitrates, alkaline earth metal hydroxides, and a mixture thereof.

Suitable examples of the alkaline earth metal may include Be, Ca, Mg, Sr, Ba, Ra, or a combination thereof. Suitable examples of alkaline earth metal oxides may include CaO, MgO, SrO, BaO, or a combination thereof, suitable examples of alkaline earth metal nitrates may include Ca(NO₃)₂, Mg(NO₃)₂, Sr(NO₃)₂, Ba(NO₃)₂, or a combination thereof, and suitable examples of alkaline earth metal hydroxides may include Ca(OH)₂, Mg(OH)₂, Sr(OH)₂, Ba(OH)₂, or a combination thereof. Specific examples of carbonate may include CaCO₃, MgCO₃, SrCO₃, BaCO₃, or a combination thereof.

When water is used as a solvent and the incinerated ash contains calcium oxide, for example, carbonate ions are consumed by the following reactions, and thus the carbonate is generated.

CaO+H₂P→Ca²⁺+2OH⁻

CO₂+H₂O→2H⁺+CO₃²⁻

Ca²⁺+CO₃²⁻→CaCO₃

As shown in FIG. 1, the sensor S detects the concentration of CO₂ in the second gas. The sensor S is not particularly limited as long as it can detect the concentration of CO₂ in the gas, and is, for example, a CO₂ concentration meter, a CO₂ concentration analyzer or the like. The sensor S is not limited to the CO₂ concentration meter or the CO₂ concentration analyzer, and may be a sensor capable of indirectly detecting the concentration of CO₂ in the second gas.

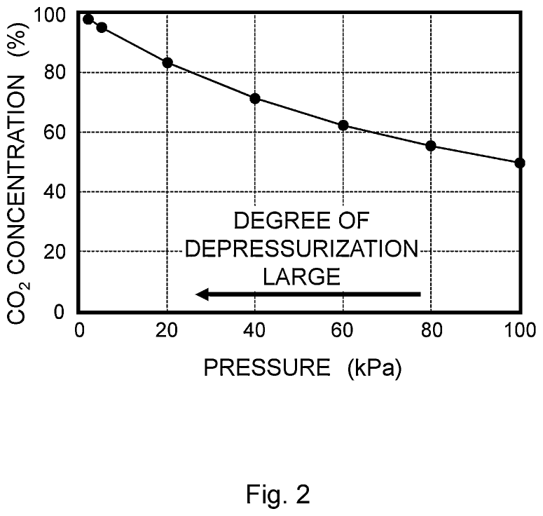

FIG. 2 is a graph showing a relation between a pressure when CO₂ is extracted and the CO₂ concentration. As shown in FIG. 2, the lower the gas pressure and the greater the degree of depressurization, the higher the CO₂ concentration. Here, the atmospheric pressure is 101.3 kPa. As shown in FIG. 2, by acquiring the relationship between the pressure when CO₂ is extracted and the CO₂ concentration in advance, the CO₂ concentration can be detected from the pressure of the second gas. That is, the sensor S may be a pressure sensor that detects the pressure of the second gas.

The target concentration range of the CO₂ concentration is a concentration range where excessive CO₂ that does not react with the alkaline earth compounds can be reduced while reducing a reaction time with the alkaline earth compounds. The target concentration range of the CO₂ concentration is determined as appropriate depending on the concentration or the like of the alkaline earth compounds in the carbonate generation apparatus 200 and can be changed as appropriate depending on the progress of the reaction with the alkaline earth compounds, or the like.

As described above, in the carbon dioxide immobilization system according to this embodiment, the degree of depressurization in the CO₂ capture apparatus 100 is controlled by feedback in such a way that the concentration of CO₂ in the second gas extracted from the CO₂ capture apparatus 100 is maintained within a predetermined target concentration range. Therefore, when carbonate is generated and CO₂ is immobilized, CO₂ in the second gas can be maintained to be within the predetermined target concentration range, and it is thus possible to reduce excessive CO₂ while reducing the reaction time.

### <Carbon Dioxide Immobilization Method>

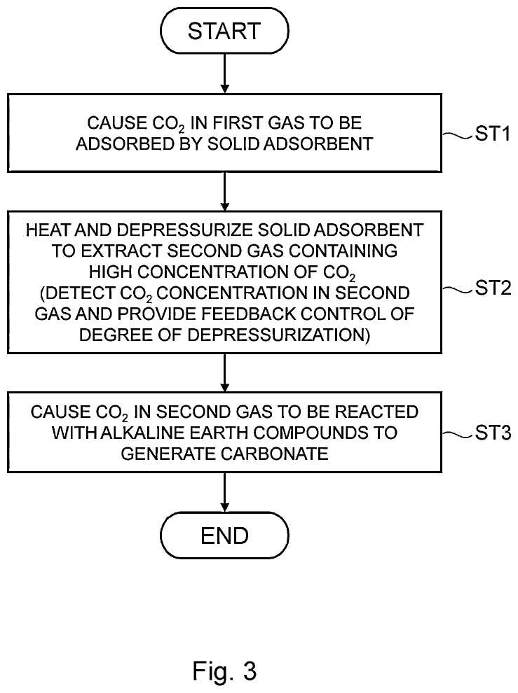

Next, with reference to FIG. 3, a carbon dioxide immobilization method according to the first embodiment will be described. FIG. 3 is a flowchart showing the carbon dioxide immobilization method according to the first embodiment. In the description of FIG. 3, FIG. 1 is referred to as appropriate.

First, as shown in FIG. 3, CO₂ in the first gas is adsorbed by the solid adsorbent of the CO₂ adsorption unit 101 shown in FIG. 1 (Step ST1).

Next, as shown in FIG. 3, the CO₂ adsorption unit 101 that has adsorbed CO₂ (i.e., the solid adsorbent) is heated by the heater 102 and is depressurized by the depressurizing pump 103. According to this configuration, the second gas containing a higher concentration of CO₂ than the first gas does is extracted from the CO₂ capture apparatus 100 (Step ST2).

In this Step ST2, the controller 104 performs feedback control on the depressurizing pump 103 based on the concentration of CO₂ in the second gas detected by the sensor S. More specifically, the controller 104 provides feedback control of the degree of depressurization in the CO₂ adsorption unit 101 by the depressurizing pump 103 in such a way that the concentration of CO₂ detected by the sensor S is maintained within a predetermined target concentration range.

Lastly, as shown in FIG. 3, in the carbonate generation apparatus 200 shown in FIG. 1, CO₂ in the second gas and alkaline earth compounds are reacted to generate carbonate (Step ST3).

As described above, in the carbon dioxide immobilization method according to this embodiment, the degree of depressurization when CO₂ is extracted is controlled by feedback in such a way that CO₂ in the second gas extracted from the solid adsorbent is maintained within a predetermined target concentration range. Therefore, when carbonate is generated and CO₂ is immobilized, CO₂ in the second gas can be maintained within a predetermined target concentration range, and it is thus possible to prevent the causing of an excessive amount of carbon dioxide while reducing the reaction time.

The present disclosure contributes to carbon neutral, decarbonization, and Sustainable Development Goals (SDGs).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A carbon dioxide immobilization system comprising:
a carbon dioxide capture apparatus in which a solid adsorbent is caused to adsorb carbon dioxide in a first gas, then the solid adsorbent is heated and depressurized, and a second gas containing a higher concentration of carbon dioxide than the first gas does is extracted;
a carbonate generation apparatus configured to cause carbon dioxide in the second gas extracted from the carbon dioxide capture apparatus to be reacted with an alkaline earth compound to generate carbonate; and
a sensor configured to detect a concentration of carbon dioxide in the second gas,
wherein a degree of depressurization in the carbon dioxide capture apparatus is controlled by feedback in such a way that the concentration of carbon dioxide detected by the sensor is maintained within a predetermined target concentration range.

2. The carbon dioxide immobilization system according to claim 1, wherein the degree of depressurization is increased when the concentration of carbon dioxide detected by the sensor is lower than the predetermined target concentration range, and the degree of depressurization is decreased when the concentration of carbon dioxide detected by the sensor is higher than the predetermined target concentration range.

3. The carbon dioxide immobilization system according to claim 1, wherein the alkaline earth compound is included in incinerated ash, slag, or seawater.

4. A carbon dioxide immobilization method comprising:
causing a solid adsorbent to adsorb carbon dioxide in a first gas;
heating and depressurizing the solid adsorbent and extracting a second gas containing a higher concentration of carbon dioxide than the first gas does; and
causing carbon dioxide in the extracted second gas to be reacted with an alkaline earth compound to generate carbonate, wherein
when the second gas is extracted,
a concentration of carbon dioxide in the extracted second gas is detected, and
a degree of depressurization when carbon dioxide is extracted from the solid adsorbent is controlled by feedback in such a way that the detected concentration of carbon dioxide is maintained within a predetermined target concentration range.

5. The carbon dioxide immobilization method according to claim 4, wherein the degree of depressurization is increased when the detected concentration of carbon dioxide is lower than the predetermined target concentration range and the degree of depressurization is decreased when the detected concentration of carbon dioxide is higher than the predetermined target concentration range.

6. The carbon dioxide immobilization method according to claim 4, wherein the alkaline earth compound is included in incinerated ash, slag, or seawater.
